(19) United States
(12) Patent Application Publication
(10) Pub. No.: US 2005/0134711 A1
(43) Pub. Date: Jun. 23, 2005

(54) Drag-and-drop digital camera gamma correction

(75) Inventor: Toshikazu Hori, Milpitas, CA (US)

Correspondence Address: LAW OFFICES OF THOMAS E. SCHATZEL;A Professional Corporation, Suite 240, 16400 Lark Avenue, Los Gatos, CA, 95032-2547, US

(73) Assignee: JAI PULNIX, INC.

(21) Appl. No.: 11/041,153

(22) Filed: Jan. 20, 2005

Related U.S. Application Data
(63) Continuation-in-part of application No. 09/558,003, filed on Apr. 24, 2000, now abandoned.

(51) Int. Cl. H04N 5/202

(52) U.S. Cl. 348/254

(57) ABSTRACT

A CCD video camera system comprises a CCD imaging device connected to a low-gain amplifier. An analog-to-digital converter converts the analog output of the amplifier to a full-range digital video signal. Such addresses a digital look-up table to produce a digital video output according to one of several selectable range-correction curves. Such range-correction curves comprise two linear slopes that join at a knee, and the two linear parts have two different gain slopes. The range-correction curves are selected on the basis of the gain slope of the first of the two linear slopes, and the knee-point.

### RELATED APPLICATIONS

This is a continuation-in-part of U.S. patent application Ser. No. 09/558,003, filed Apr. 24, 2000, and titled, VIDEO GLARE REDUCTION, by the present inventor, Toshikazu HORI, et al.

### 1. FIELD OF THE INVENTION

The present invention relates to video cameras, and more particularly to methods and circuits for the easy adjustment of video gamma values to obtain picture details in the shadows without allowing other areas to glare.

### 2. DESCRIPTION OF THE PRIOR ART

The typical charge-coupled device (CCD) array can provide as much as 500 mV of dynamic range. But at some point, increasing light levels will not produce increased signal output, because the CCD array will saturate. It is quite common for a CCD array to be followed by a stage of amplification that limits the dynamic output range of the camera to as little as one-tenth of the range possible. Only a small portion of the linear operating region of the CCD array is used. Such amplifiers also bring up the picture brightness to make a more pleasing display. Displays taken directly from the CCD array, or where gains in the amplifier are set low, usually result in pictures that appear too dark.

A user often has to be able to adjust the camera gain to be able to pick out various items-of-interest in a video picture. For example, various lighting conditions and weather changes can change the optimum gain needed to discern license plate numbers in video images obtained by parking lot cameras. An operator has to vary the camera gain in order to see each car's license plate number clearly. This phenomenon prevents automatic recognition systems from operating efficiently, and slows down manually operated systems.

### SUMMARY OF THE INVENTION

It is therefore an object of the present invention to provide a camera system that can better use the dynamic range of a CCD image array.

It is another object of the present invention to provide a CCD imaging system that is inexpensive to manufacture.

Briefly, a CCD video camera system embodiment of the present invention comprises a CCD imaging device connected to a low-gain amplifier. An analog-to-digital converter converts the analog output of the amplifier to a full-range digital video signal. Such addresses a digital look-up table to produce a digital video output according to one of several selectable range-correction curves. Such range-correction curves comprise two linear slopes that join at one knee or three slopes joined by two knees. Each the linear parts have different gain slopes. The range-correction curves are selected on the basis of the gain slope of the linear slopes, and the knee-points.

An advantage of the present invention is that a CCD camera system is provided that can provide increased image details in darker areas of a picture.

Another advantage of the present invention is that a CCD imaging system is provided that can be used in systems that automatically adapt to a variety of lighting conditions and imaging targets.

These and other objects and advantages of the present invention will no doubt become obvious to those of ordinary skill in the art after having read the following detailed description of the preferred embodiments which are illustrated in the drawing figures.

### IN THE DRAWINGS

FIG. 1 is a functional block diagram of a camera system embodiment of the present invention;

FIG. 2 is a graph representing the dual-slope transfer functions that can be stored as digital tables in the look-up table of FIG. 1;

FIG. 3 is a functional block diagram of a camera system embodiment of the present invention that includes a personal computer with drag-and-drop gamma correction capabilities;

FIG. 4 is a flow chart of a software embodiment of the present invention that implements the drag-and-drop gamma correction capabilities on the personal computer of FIG. 3; and

FIG. 5 is a diagram representing a dynamic sectionalized gamma correction system embodiment of the present invention.

### DETAILED DESCRIPTION OF THE PREFERRED EMBODIMENT

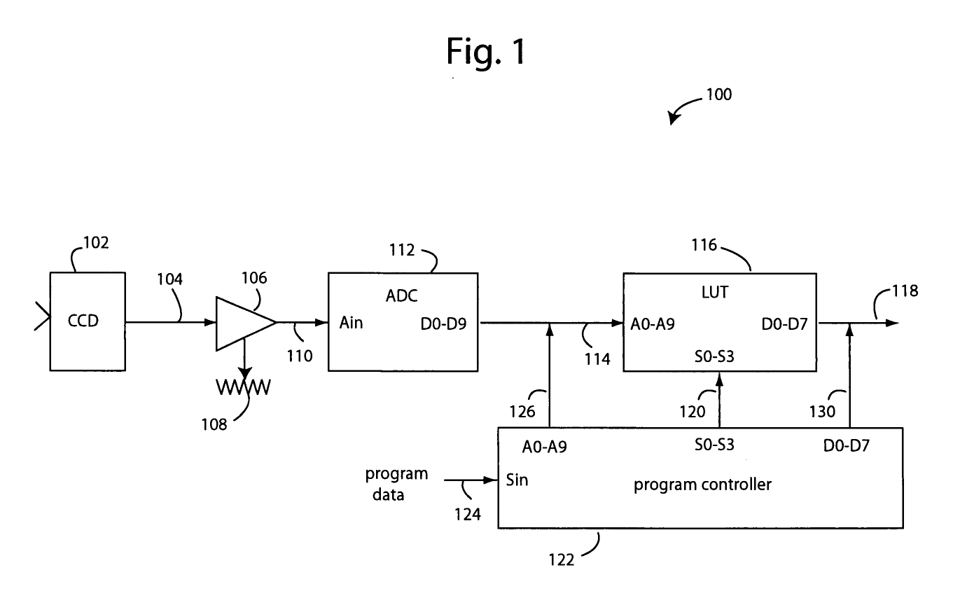

A camera system embodiment of the present invention is illustrated in FIG. 1 and is referred to herein by the general reference numeral 100. The system 100 includes a CCD-imaging device 102 that produces a CCD-signal 104. An amplifier 106 set at a relatively low gain by an adjustment 108 helps produce an amplified analog signal 110. An analog-to-digital converter (ADC) 112 produces, e.g., a ten-bit digital video output signal 114. The gain of amplifier 106 is preferably set so that the dynamic output range of CCD 102 matches the digital dynamic range of ADC 112. A look-up table (LUT) 116 converts each digital input word in digital video output signal 114 to a modified word in a system output signal 118, e.g., an eight-bit value. A curve-selection signal 120, e.g., a four-bit digital value, is used to choose which predetermined correction curve inside LUT 116 is to be used. Each range-correction curve comprises two linear slopes that join at a knee and have different gain slopes. The range-correction curves are selected on the basis of the gain slope of the first of the two linear slopes, and the knee-point.

Therefore, the LUT 116 is not used to store the equivalent of a “gamma-correction” curve, which is a continuous algebraic function and usually implemented with analog techniques. Embodiments of the present invention use only dual-slope compensation conversions that can be precisely controlled with digital techniques and devices. Such also are not continuous algebraic functions, and comprise exactly two linear segments with different gains and joined at a knee-point.

In alternative embodiments of the present invention, the LUT 116 is programmable and downloadable. Such can be useful to load and store the initial look-up tables stored by LUT 116 and selected by signal 120. If LUT 116 is made programmable and downloadable, such can also be useful in applications where the optimum dual-slope compensation conversions need to be empirically derived.

For example, a download and reprogramming controller 122 receives new dual-slope transfer functions to load in LUT 116 from a program data signal 124 at a serial input port. The LUT 116 is placed in a reprogramming mode. An address output signal 126 and a selection output signal force an address on the LUT 116 and a data output 130 forces a new write data on the data ports of the LUT 116. For example, the controller 122 can be a flash memory controller and the LUT 116 can be a flash memory device.

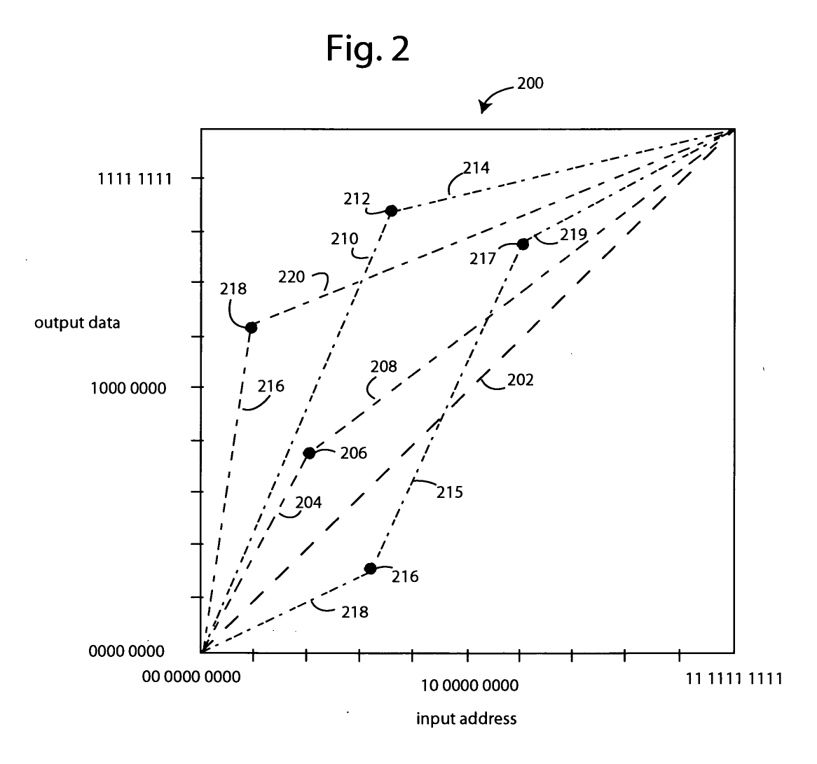

FIG. 2 represents a digital transfer function 200 that is preferably embodied in the LUT 116 (FIG. 1). Such LUT 116 can be implemented with a programmable read only memory (PROM), e.g., FLASH memory. In one embodiment of camera system 100, the LUT 116 preferably has a ten-bit input address and an eight-bit data output. Therefore, the digital transfer function 200 is illustrated in FIG. 2 with a X-coordinate that ranges from digital binary 00,0000,0000 at zero to 11,1111,1111 at full scale. Such input produces a transfer function that outputs on the Y-coordinate that ranges from digital binary 0000,0000 at zero to 1111,1111 at full scale.

A number of selectable transfer functions are shown included in the digital transfer function 200. A straight linear transfer function 202 is included for illustration purposes only. A linear transfer function could be included in LUT 116, but probably would not be used in most applications of camera system 100. A first dual-slope transfer function has a high-gain linear slope 204 that breaks at a knee-point 206 and continues in a lower-gain linear slope 208. A second dual-slope transfer function has a high-gain linear slope 210 that breaks at a knee-point 212 and continues in a lower-gain linear slope 214. A third dual-slope transfer function has a high-gain linear slope 216 that breaks at a knee-point 218 and continues in a lower-gain linear slope 220.

A fourth transfer function is different. A high gain linear slope 215 is needed in the mid-range. It ranges between a pair of knee-points 216 and 217. A pair of lower gain slopes 218 and 219 are used in the extremes of dark and light.

In alternative embodiments of the present invention, three or more knee-points are used and are joined by a multitude of interconnection linear slopes of various gains. It can happen in particular applications that more than one portion of the dynamic range requires high-gain.

The LUT 116 could contain many more such dual-slope and multi-slope transfer functions all selectable by signal 120. Those illustrated in FIG. 2 are simply used to describe the concepts needed for successful implementations.

The lower ranges of the input address and output data in FIG. 2 represent the darker scenes in a digital video image. The increased gains represented by slopes 204, 210, and 216, over linear slope 202, produces video images with enhanced details. One or more of these may be preferred by a user or automatic image recognition system to pull up details of interest in a particular video frame.

In alternative embodiments of the present invention, a particular one of the dual-slope transfer functions 204-220 may be applied to every pixel in a video frame. Or, the dual-slope transfer functions 204-220 may be applied one at a time to sections of a video frame. For example, the top half of a video frame may produce better images for things-of-interest if the dual transfer function 204-208 is selected. But, the bottom half of the video frame may produce better images for things-of-interest if the dual transfer function 210-214 is selected. Of course, the opposite can be implemented wherein the brighter or top-end range has the most gain. In FIG. 2, such would involve knee-points that are below linear slope 202.

Embodiments of the present invention are particularly useful in manufacturing quality control. For example, fine scratches in the surfaces of silicon wafers and chips can be discerned even in the presence of shimmer, glare, and reflections. In the automated manufacturing of glass bottles and containers, cracks and other defects in the glass itself can be spotted even when the lighting conditions are otherwise adverse. In some applications, backlighting needed to candle the pieces can be eliminated. Even sunset lighting conditions that can ordinarily produce impossible glare conditions can be tolerated in automatic vehicle license plate recognition systems.

Some prior art devices apply image processing techniques where the gain of darker or lighter video frames has increased gain, but such do not have the full dynamic range of the original CCD output 104 to work with. Therefore, a large amount of possible resolution is unavailable in such prior art devices.

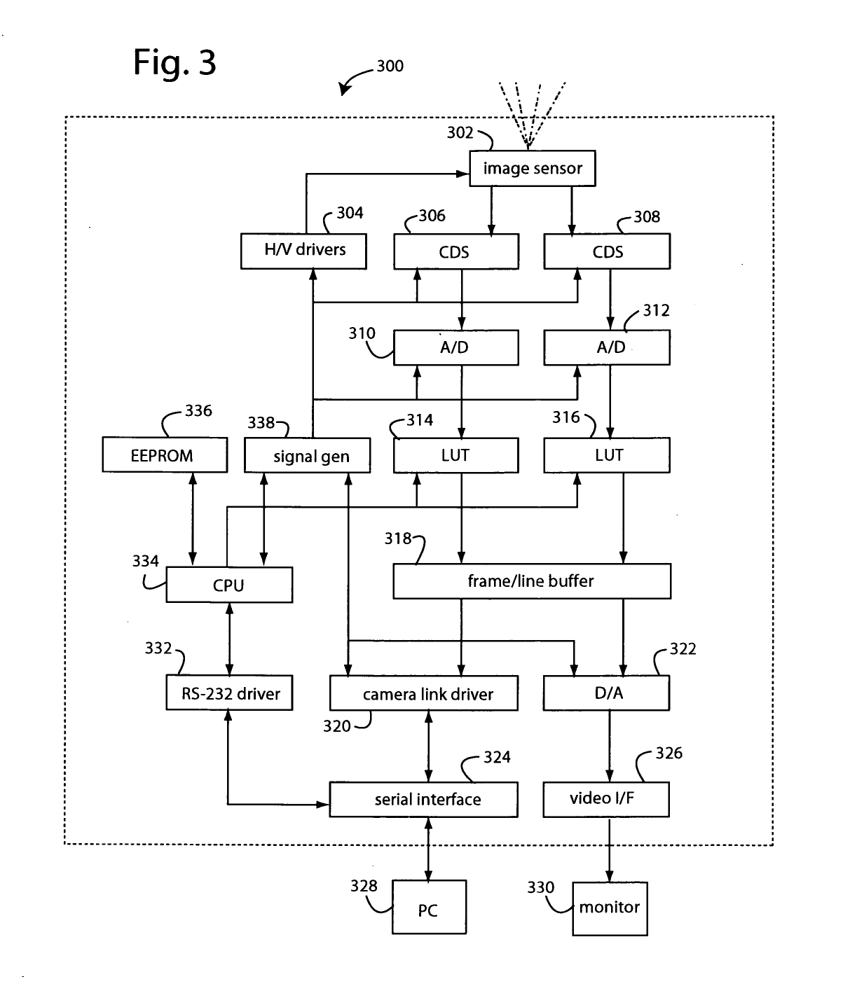

FIG. 3 represents a camera system embodiment of the present invention, and is referred to herein by the general reference numeral 300. A CCD image sensor 302 produces A-channel and B-channel analog outputs. Such is powered by high-voltage (H/V) drivers 304. Respective correlated double samplers (CDS) 306 and 308 remove noise from the raw samples. Before the charge of each pixel is transferred to the output node of the CCD, the output node is reset to a reference value. The pixel charge is then transferred to the output node. The final value of charge assigned to this pixel is the difference between the reference value and the transferred charge. This process is referred to as correlated double sampling. Correlated double sampling yields the best representation of the true charge associated with each pixel.

The A-channel and B-channel analog signals are then converted to digital by respective analog-to-digital (A/D) converters 310 and 312. The digital representations are then transformed by look-up tables (LUT) 314 and 316. These implement gamma correction and the transformations are selectable and adjustable by the user, e.g., via a USB, Ethernet, or other data network interface. For example, the two-knee gamma correction curves represented in FIG. 2 are stored in the LUT's 314 and 316. In some applications, it is desirable to parse each video frame into sections and apply a different gamma correction to each. At the extreme, the individual pixels can be mapped to have independent gamma corrections respective to their neighbors. These corrections can be applied on-the-fly, according to pixel location, time, frame number, colors detected, motion detected, etc. The selections are implemented through drag-and-drop GUI's presented on a personal computer monitor.

At any specific gain setting, the minimum level-dark point offset and the A/D saturation point maximum level are set to a 10-bit input. This way the full dynamic range of the CCD image sensor 302 is completely utilized. In one embodiment, the output of LUT 314 and 316 is converted to 8-bit.

The gamma-corrected outputs of the A-channel and B-channel are collected by a frame/line buffer 318. A camera link driver 320 and digital-to-analog (D/A) converter 322 receive the assembled video frames. A serial interface 324, e.g., USB, Ethernet, FireWire, etc., provides a digital video and command interface. A video interface (I/F) 326 provides an analog output in a standardized format, e.g., PAL, NTSC, RGB, etc. A personal computer (PC) 328, or web browser, and video monitor 326 are able to display the processed image received by image sensor 302. PC 328 is also able to support a GUI with a drag-and-drop user interface to change the transformations stored in LUT's 314 and 316.

A standard RS-232 serial interface 332 connects to an embedded microprocessor (CPU) 334. Such executes a program and accesses data stored in a memory (EEPROM) 336. A signal generator 338 converts input-output commands from CPU 334 to control H/V drivers 304, CDS 306 and 308, and A/D 310 and 312. The CPU 334 receives drag-and-drop commands from PC 328 and adjusts the gamma corrections stored in LUT 314 and 312.

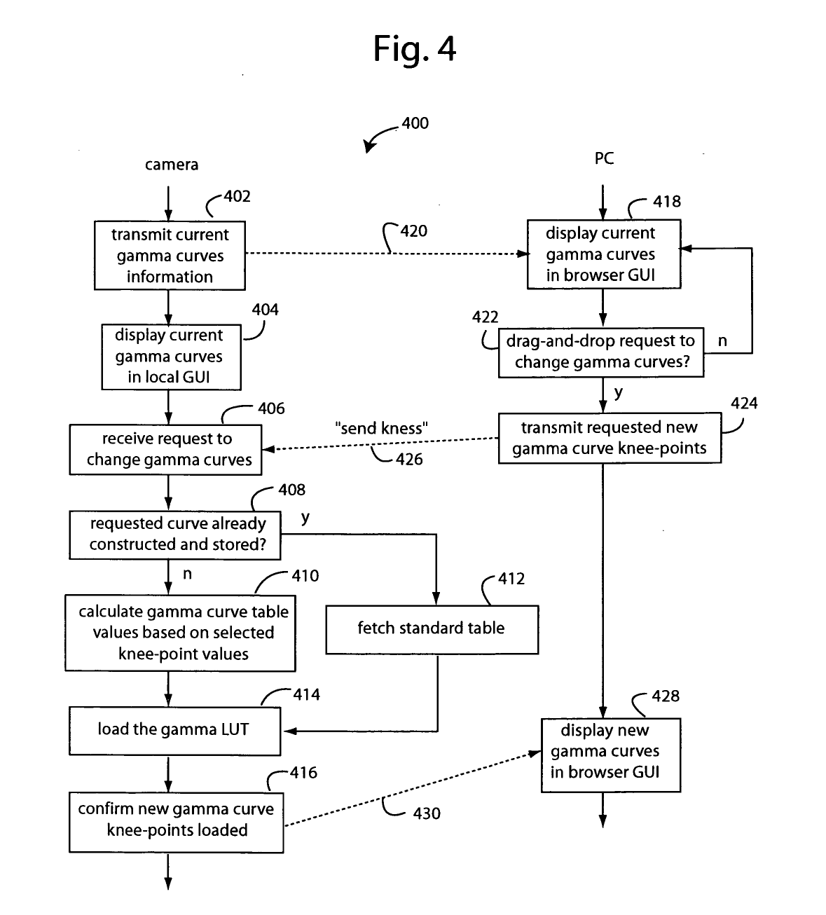

FIG. 4 represents a software embodiment of the present invention, and is referred to herein by the general reference numeral 400. Such software 400 has two parts that communicate with each other over a communications link, e.g., a fast USB, Gigabit Ethernet, or broadband Internet connection between serial interface 324 and PC 328 in FIG. 3. The first part is executed by CPU 334 and the second part by PC 328, e.g., with a web browser. The software 400 comprises a step 402 that transmits the current gamma curve information loaded in LUT 314 and 316. A step 404 presents it in a local LCD user display panel. A step 406 receives requests to use a new gamma correction curve, e.g., from user buttons provided on the camera. A step 408 looks to see if the requested gamma curve is a standard one or must be calculated. If not standard, then a step 410 calculated the entire transfer function based on a limited set of knee-points. If standard, then a step 412 fetches the respective precalculated table from memory. A step 414 loads the LUT 314 and 316, e.g., by a write command from CPU 334. A step 416 confirms the new gamma curve is loaded, e.g., with a message to a user display.

On the PC-side, a step 418 receives a communication 420 and uses them to display current gamma curves in a GUI, e.g., a window in a browser. A drag-and-drop request 422 is generated when a user clicks on a gamma curve represented in the GUI and drags it to a new X,Y point. Actual X,Y values may also be numerically entered instead of using the mouse to drag the knee-points. The display updates to make the curve include the new knee-point. A step 424 transmits the final knee-points in a message 426 when a “send knees” button is clicked. A step 428 receives a confirmation message 430 and displays the new gamma curve in the GUI.

In commercial embodiments, the browser window GUI includes controls for shutter mode and speed, normal and binning scan modes, gain, look-up table gamma correction, double-knee control, and is able to write to and read settings from EEPROM 336. A set of eight precalculated tables are included standard.

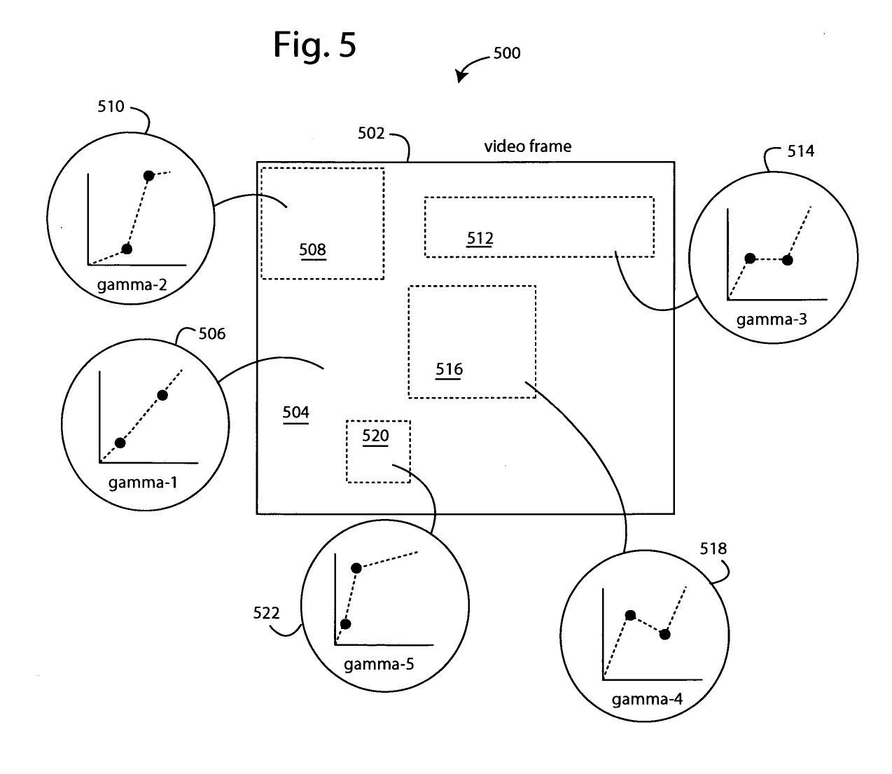

FIG. 5 represents a dynamic sectionalized gamma correction system embodiment of the present invention, and is referred to herein by the general reference numeral 500. The big black dots in FIG. 5 represent the knee-points. The system 500 includes a video frame 502 produced by camera system 300, FIG. 3. An arbitrary number of scene sections of video frame 502 have been processed with different gamma corrections. The size and location of each scene section is user adjusted to concentrate on some activity of interest in view of the camera, and can be relocated and resized over time. For example, the camera is fixed and an object of interest will be known to appear in a particular portion of the image. The nature of the object is that special gamma correction is needed to image just it properly. Other objects in the same frame will need different gamma corrections, or the ability to trial-and-error a number of test curves.

A main body 504 of video frame 502 receives gamma-1 correction 506. An upper-left section 508 receives gamma-2 correction 510. An upper-right section 512 receives gamma-3 correction 514. A middle section 516 receives gamma-4 correction 518. And a small lower-left section 520 receives gamma-5 correction 522. Each of these gamma correction tables is accessible to system 400 of FIG. 4 and executable in system 300 of FIG. 3.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention.

1. A video camera system, comprising:
an image sensor and analog-to digital converter that provide digital values for individual pixels in a video frame;
a re-writeable digital look-up table (LUT) connected to receive said digital values and to gamma correct them according to a digitally loadable gamma correction curve;
a processor for loading a variety of gamma correction curves into said LUT in response to a user input; and
a video output representing a gamma corrected version of said video frame of a scene imaged by the image sensor.

2. The system of claim 1, wherein:
the LUT can be loaded and re-loaded with more than one different gamma correction curve within the progress of a single video frame.

3. The system of claim 1, wherein:
the LUT can be loaded with different gamma correction curves that each independently affect different sections of said video frame on-the-fly.

4. The system of claim 1, wherein:
the LUT can be loaded with different gamma correction curves that are calculated by the processor according to user-provided knee-points.

5. The system of claim 1, wherein:
the LUT can be loaded with different gamma correction curves that are standardized and fetched from a memory by the processor according to user provided knee-points.

6. The system of claim 1, wherein:
the LUT can be loaded with different gamma correction curves that are selected by a user operating a drag-and-drop graphical user interface (GUI).

7. The system of claim 1, wherein:
the LUT can be loaded with different gamma correction curves that are selected by a user who enters X,Y coordinates desired for a plurality of knee-points in graphical user interface (GUI).

8. The system of claim 1, wherein:
the LUT can be loaded with different gamma correction curves by the processor when in communication with a remote personal computer and browser in which a user enters X,Y coordinates desired for a plurality of knee-points in graphical user interface (GUI).

9. The system of claim 1, wherein:
the LUT can be loaded with different gamma correction curves by the processor when in communication with a remote personal computer and browser in which a user drags-and-drops individual X,Y coordinates desired for a plurality of knee-points in graphical user interface (GUI).
